(19) United States
(12) Patent Application Publication
(10) Pub. No.: US 2024/0285987 A1
(43) Pub. Date: Aug. 29, 2024

(54) FIRE BARRIER

(71) Applicant: POLYSEAM LIMITED, Huddersfield (GB)

(72) Inventors: David ALLEN, Huddersfield (GB); Kjetil BOGSTAD, Huddersfield (GB); Neil HEFFERNAN, Huddersfield (GB)

(21) Appl. No.: 18/572,362

(22) PCT Filed: Jul. 26, 2022
(86) PCT No.: PCT/GB2022/051953

§ 371 Date: Dec. 20, 2023

(30) Foreign Application Priority Data
Jul. 30, 2021 (GB) 2111016.8
Feb. 11, 2022 (GB) 2201799.0

(51) Int. Cl. A62C 2/06

(52) U.S. Cl. CPC A62C 2/065

(57) ABSTRACT

A fire barrier product for a cavity comprising a compressed expandable non-combustible material, an intumescent composition, an expandable covering and a heat-frangible covering.

The present invention relates to fire barriers and to methods and uses relating thereto. In particular the invention relates to fire barriers for use in vented cavities.

Cavities may exist, for example between the wall of the building and external cladding or between the eaves of a roof and the top of a wall.

Fire barriers are incorporated within cavities of a building's structure in order to prevent fire from spreading between partitions or floors in a building. Such barriers commonly completely close the cavity. However in some instances cavities need to remain open to allow ventilation, drainage and/or access in normal service. This can cause significant issues in case of a fire as the fire can spread rapidly between floors and partitions in an uncontrolled manner.

A number of solutions to this problem have been proposed. For example barriers having ventilation strips or holes which are closable by an intumescent material are known. Also known are barriers that do not completely span across a cavity but are able to expand through intumescence to close the remaining gap. However the distance across which such materials can expand is limited due to the lack of support for the intumescent material.

Another solution is mechanical system in which a cavity is held open during normal use. A magnetic or electrical signal is switched on or off in the event of a fire, causing the mechanical system to close the cavity.

A disadvantage of these mechanical systems is that regular inspections and testing are needed to ensure that they are in working order. It can also be complex to retrofit mechanical systems to buildings due to the necessity of including electrical or magnetic components.

The present invention seeks to provide an alternative fire barrier which offers advantages over some barriers of the prior art.

According to a first aspect of the present invention there is provided a fire barrier product for a cavity comprising a compressed expandable non-combustible material, an intumescent composition, an expandable covering and a heat-frangible covering.

The compressed expandable non-combustible material may be selected from any suitable material that is able to be compressed and which does not burn.

Suitably the compressed expandable non-combustible material is selected from man made mineral fibres (MMMFs) and man made vitreous fibres (MMVFs).

Preferably the compressed expandable non-combustible material is selected from one or more of mineral wool, mineral fibres, mineral cotton, vitreous fibres, stone wool, slag wool, glass wool, ceramic fibre, ceramic wool and other man made fibres.

The compressed expandable non-combustible material is thus suitably a fibrous material and the fibres are provided in a compressed state.

The intumescent composition may be selected from any suitable composition that swells and produces a char on exposure to heat. Intumescent compositions typically comprise a binder, an acid source, a gas source, and a carbon source.

The intumescent composition suitably comprises (a) an intumescent material comprising phosphorus, sulfur, a halogen, a melamine compound, boron, a polyol or a mixture thereof. Intumescent materials of this type are well known to the person skilled in the art.

Component (a) may comprise phosphorus. By this we mean to include any compound comprising a phosphorus atom or ion. Such compounds include, but are not limited to, phosphates, polyphosphates and other phosphoric acid salts and derivatives.

Component (a) may comprise sulfur. By this we mean to include any compound comprising a sulfur atom or ion. Such compounds include, but are not limited to, sulfates and other sulfuric acid salts and derivatives.

Component (a) may comprise boron. By this we mean to include any compound comprising a boron atom or ion. Such compounds include, but are not limited to, borates and other boric acid salts and derivatives.

Component (a) may comprise a halogen. By this we mean to include any compound comprising a halogen atom or halide ion. Such compounds include, but are not limited to, chloride and bromide salts.

Component (a) may comprise one or more compounds selected from ammonium polyphosphate, phosphoric acid, sulphuric acid, boric acid, salts of boric acid, ammonium tetraborate, potassium tetraborate, sodium tetraborate, ammonium phosphate, ammonium sulphate, ammonium halides, urea, guanylurea phosphate, reaction products of P₂O₅ and ammonia, tricresyl phosphate, alkyl phosphate, haloalkyl phosphates, melamine, melamine cyanurate, melamine phosphate, melamine pyrophosphate, melamine polyphosphate, dicyandiamide, azodicarbonamide, linear amines (e.g. ethylene diamine-o-phosphate), guanidine phosphate, melamine borate, melam, melem, melon, pentaerythritol, dipentaerythritol, tripentaerythritol, starch, sugar, glucose, dextrin, sorbitol, mannitol, phenol formaldehyde resins, and methylol melamine.

In some preferred embodiments component (a) comprises a phosphorous containing intumescent material. Suitably component (a) comprises a phosphate-containing intumescent material.

In some especially preferred embodiments component (a) comprises ammonium polyphosphate.

In some preferred embodiments component (a) comprises a melamine compound. Preferably component (a) comprises melamine.

In some embodiments component (a) comprises a polyol, i.e. a polyhydric alcohol. Suitable polyhydric alcohols include sugars and other carbohydrates.

Preferred polyols are pentaerythritol, dipentaerythritol and tripentaerythritol. Pentaerythritol is especially preferred.

In some embodiments component (a) comprises a mixture of compounds.

In some embodiments component (a) comprises a first material selected from ammonium polyphosphate, phosphoric acid, sulphuric acid, boric acid, salts of boric acid, ammonium tetraborate, potassium tetraborate, sodium tetraborate, ammonium phosphate, ammonium sulphate, ammonium halides, urea, guanylurea phosphate, reaction products of P₂O₅ and ammonia, tricresyl phosphate, alkyl phosphate and haloalkyl phosphates; a second material selected from melamine, melamine cyanurate, melamine phosphate, melamine pyrophosphate, melamine polyphosphate, dicyandiamide, azodicarbonamide, linear amines (e.g. ethylene diamine-o-phosphate), guanidine phosphate, melamine borate, melam, melem, melon; and a third material selected from pentaerythritol, dipentaerythritol, tripentaerythritol, starch, sugar, glucose, dextrin, sorbitol, mannitol, phenol formaldehyde resins, and methylol melamine.

In some preferred embodiments component (a) comprises a first material selected from ammonium polyphosphate, ammonium tetraborate and ammonium phosphate; a second material selected from melamine and dicyandiamide; and a third material selected from pentaerythritol, dipentaerythritol and tripentaerythritol.

Suitably component (a) comprises a phosphate-containing compound and a melamine compound. Preferably component (a) comprises ammonium polyphosphate and melamine.

In some especially preferred embodiments component (a) further comprises a polyol. Suitably component (a) comprises a phosphate-containing compound, a melamine compound and a pentaerythritol compound.

The intumescent composition may further comprise (b) an expandable intumescent material selected from graphite, silicate, vermiculite and mixtures thereof. Materials of this type are known to the person skilled in the art. Preferably component (b) comprises an expandable graphite material.

The intumescent composition may further comprise (c) a polymeric binder. Suitable polymeric binders include styrene/acrylic copolymers, vinyl acetate polymers, vinyl acetate/VeoVa/acrylate copolymers, acrylic polymers, acrylic/VeoVa copolymers, acrylic/styrene copolymers, styrene/butadiene copolymers, styrene/butadiene/acrylonitrile copolymers, polybutadiene polymers, alkyd polymers, epoxy polymers, polyurethane modified silanes, silicones, polysulphides, polyaspartic polymers and polyurethane polymers. VeoVa refers to the vinyl ester of versatic acid. As the skilled person will appreciate a number of versatic acids are available. Versatic acid 10, a highly branched isomer of decanoic acid is preferred.

Preferred polymeric binders for use in the intumescent composition are styrene/acrylic copolymers.

The polymeric binder is preferably incorporated into the composition as an aqueous emulsion. Such an emulsion typically comprises particles of the polymer suspended in an emulsion which coalesce on drying to form the polymeric binder.

The intumescent composition may further comprise (d) a fibrous material. Suitable fibrous materials include silicate fibres, mineral fibres, aramid fibres, carbon fibres, imide fibres, cellulosic fibres and diatomaceous earth fibres. Especially preferred fibrous materials are alkaline earth silicate fibres. Suitably the fibres are from 1 μm to 1 mm in diameter.

In some embodiments the intumescent composition may comprise:
(a) an intumescent material comprising phosphorus, sulphur, a halogen, a melamine compound, boron, a polyol or a mixture thereof;
(b) an expandable intumescent material selected from graphite, silicate, vermiculite and mixtures thereof;
(c) a polymeric binder; and
(d) a fibrous material.

In some embodiments the intumescent composition may comprise (e), an inorganic filler.

Suitable inorganic fillers include titanium dioxide, kaolin, barytes, perlite (aluminium silicate), cenospheres, carbonates (e.g. calcium carbonate and dolomite), metal hydroxides (e.g. aluminium hydroxide, magnesium hydroxide), huntite, hydromagnesite, vermiculite (mica), portland cement clinker, glass, plaster of paris (gypsum), calcined kaolin, fly ash, slag, calcium sulfate, silica gel, silicates (e.g. calcium silicate), silica (quartz), talc, wollastonite, zinc stearate, zinc oxide, aluminium oxide, zeolite, Ceepree (glass frits), lead oxide, silicon and borates (e.g. potassium tetraborate, potassium borate, ammonium tetraborate, sodium borate).

An especially preferred filler is titanium dioxide.

Component (a) is preferably present in the intumescent composition in an amount of at least 5 wt %, suitably at least 10 wt %, preferably at least 15 wt %, preferably at least 20 wt %, more preferably at least 25 wt %, for example at least 30 wt % or at least 35 wt %.

Component (a) may be included in the composition in an amount of up to 80 wt %, suitably up 25 to 70 wt %, preferably up to 65 wt %, suitably up to 60 wt %, more preferably up to 55 wt %, for example up to 50 wt % or up to 45 wt %.

In embodiments in which component (a) comprises a mixture of compounds the above amounts refer to the total of all such compounds present in the composition.

In some embodiments the composition comprises ammonium phosphate or ammonium polyphosphate in an amount of from 10 to 40 wt %, suitably from 15 to 35 wt %, preferably from 20 to 30 wt %, for example from 22 to 28 wt %.

In some embodiments the composition includes a melamine component in an amount of from 1 to 20 wt % preferably from 2 to 15 wt %, suitably from 5 to 10 wt %.

In some embodiments the composition comprises a pentaerythritol component in amount of 1 to 20 wt % preferably from 2 to 15 wt %, suitably from 5 to 10 wt %.

In some especially preferred embodiments the intumescent composition comprises from 15 to 35 wt % of ammonium polyphosphate, from 2 to 15 wt % of melamine, and from 2 to 15 wt % of pentaerythritol.

Component (b) is preferably present in the intumescent composition in amount of at least 1 wt %, suitably at least 2.5 wt %, preferably at least 5 wt %, more preferably at least 7 wt %, for example at least 8 wt % or at least 10 wt %.

Component (b) may be included in the intumescent composition in an amount of up to 40 wt %, suitably up to 30 wt %, preferably up to 25 wt %, more preferably up to 20 wt %, for example up to 17 wt % or up to 15 wt %.

In embodiments in which component (b) comprises a mixture of compounds, the above amounts refer to the total amounts of all such compounds present in the composition.

Component (c) is a polymeric binder. This may suitably be incorporated into the composition in the form of a solution or emulsion, preferably an aqueous emulsion of polymeric binder.

The binder is suitably provided as a solution or emulsion comprising from 10 to 80 wt %, preferably from 30 to 70 wt %, typically from 35 to 65 wt % solids.

This solution or emulsion may be described as binder precursor composition.

The binder precursor composition is suitably incorporated in the intumescent composition in amount of at least 1 wt %, suitably in an amount of at least 5 wt %, preferably at least 10 wt %, more preferably at least 12 wt %, for example at least 15 wt %, at least 20 wt % or at least 25 wt %.

The binder precursor composition may be included in the composition in an amount of up to 50 wt %, suitably up to 45 wt %, more preferably up to 40 wt %, for example up to 35 wt %, up to 33 wt % or up to 30 wt %.

The binder precursor composition is suitably included in an amount to provide an intumescent composition comprising from 1 to 50 wt %, preferably from 10 to 35 wt %, and more preferably from 15 to 30 wt % polymeric binder.

Where a mixture of binders is included the above amount refers to the total amounts of all binders and binder precursor compositions included in the intumescent composition.

Component (d) is preferably present in the intumescent composition in amount of at least 0.1 wt %, preferably at least 0.25 wt %, suitably in an amount of at least 0.5 wt %, preferably at least 0.75 wt %, more preferably at least 1 wt %.

Component (d) may be included in the composition in an amount of up to 10 wt %, suitably up to 5 wt %, preferably up to 4 wt %, for example up to 3 wt %, or up to 2 wt %.

Where component (d) comprises a mixture of compounds the above amounts refer to the total of all such compounds present in the composition.

Component (e) is preferably present in the intumescent composition in amount of at least 0.1 wt %, preferably at least 1 wt %, suitably at least 2.5 wt %, preferably at least 5 wt %, more preferably at least 7 wt %.

Component (e) may be included in the composition in an amount of up to 30 wt %, suitably up to 25 wt %, preferably up to 20 wt %, more preferably up to 15 wt %, for example up to 12 wt %.

Where component (e) comprises a mixture of compounds the above amounts refer to the total of all such compounds present in the composition.

The intumescent composition may further comprise one or more solvents. Suitable solvents include water and other water-miscible solvents.

Suitably the composition comprises at least 1 wt % water, preferably at least 2.5 wt %, more preferably at least 5 wt %.

The intumescent composition may comprise up to 30 wt % water, preferably up to 20 wt %, more preferably up to 12 wt %.

The above amounts refer to water added to the composition in addition to any water included in other ingredients, for example a binder precursor composition.

The intumescent composition may comprise one or more further components selected from biocides, fragrances, fillers, adhesion agents, additional intumescents and fire-stop agents, buffers, dispersing agents, surfactants, deaerators, defoamers, surface control additives, hydrophobing agents, wetting additives, rheological additives, anti-cratering additives, radiation curing additives, anti-corrosion additives and anti-graffiti additives.

The composition may comprise a pH regulator. Any suitable pH regulator may be used and these will be known to the person skilled in the art. One suitable pH regulator is 2-amino-2-methyl-1-propanol.

Suitably the intumescent composition has a pH of from 5 to 13, suitably from 7 to 11.

The char formed by the intumescent composition suitably has sufficient structural rigidity to withstand a pressure difference of 300 Pa between the fire and non-fire sides of the barrier formed.

Suitably the composition swells to at least 5 times (500%), preferably at least 7 times (700%) of its original thickness in less than 2 minutes when heated according to the EN1363-1 (ISO 834) fire test. The temperature in the furnace after 1 minute of this test is approximately 349° C. and after 2 minutes it is approximately 445° C.

Suitably the intumescent composition intumesces at a temperature of 200° C. or less, preferably 150° C. or less, preferably 120° C. or less.

The fire barrier product of the present invention comprises an expandable covering.

The expandable covering is suitably arranged between the compressed expandable non-combustible material and the heat-frangible covering. The expandable covering may be folded or rolled such that it can expand without breaking upon expansion of the compressed expandable non-combustible material.

Suitably the expandable covering is provided around some or all (preferably all) of the compressed expandable non-combustible material. Thus the compressed expandable non-combustible material is fully or partially (preferably fully) retained within the expandable covering.

In some embodiments the expandable covering further surrounds the intumescent material.

Any suitable material can be used as the expandable covering. Suitably the expandable covering is smoke-impermeable and preferably gas-impermeable. This has the advantage that the fire barrier product provides a smoke hot gas seal on exposure to fire, preventing smoke and heat passing through the expanded fire barrier, as without, the heat could potentially ignite combustible materials on the fire-wise un-exposed side.

Suitably the expandable covering is provided in the form of a film. It may be made from any suitable material, including metals, fabrics and plastics. The material is preferably non-combustible or semi-combustible. Suitably the expandable covering comprises a metal, such as aluminium. Preferably the expandable covering is provided in the form of a metal foil, such as aluminium foil.

Preferably the melting point of the expandable covering is at least 200° C. In preferred embodiments the melting point of the expandable covering is more than 400° C., preferably more than 500° C., for example about 600° C.

The fire barrier product of the first aspect further comprises a heat-frangible covering. By heat-frangible covering we mean that the covering breaks apart on application of heat.

Suitably the heat frangible covering is arranged over the expandable covering is arranged to retain the expandable covering in position.

In some embodiments the heat-frangible covering is provided around some or all of the compressed expandable non-combustible material and the expandable covering. In such embodiments the compressed expandable non-combustible material, the intumescent composition and the expandable covering are fully or partially retained within the heat-frangible covering.

In some embodiments the intumescent composition may be fully or partially retained within the heat frangible covering.

In some embodiments the heat frangible covering may cover only a small part of the expandable covering. In such embodiments upon breaking the heat frangible covering allows the expandable covering to be fully extended. In some embodiments the heat frangible covering may cover all of the expandable covering.

Suitably the heat-frangible covering is used to hold the compressed expandable non-combustible material in a compressed state. Thus the heat-frangible covering suitably applies a compressive force to the expandable non-combustible material (through the expandable covering). The heat-frangible covering material must be sufficiently strong to hold the expandable non-combustible material in a compressed state under ambient conditions.

It is preferred that only a small portion of the expandable covering is covered by the heat frangible covering. This facilitates faster release and extension of the expandable covering and expansion of the compressed expandable non-combustible material to close the cavity.

Any suitable material which breaks or degrades on heating may be used as the heat-frangible covering.

By breaking or degrading on heating we mean that the material melts, disintegrates or falls apart upon application of heat. Suitably the heat-frangible covering is degraded by the application of heat to the extent that it releases any compressive force on the compressed expandable non-combustible material.

Suitably the heat-frangible covering is provided in the form of a film. Preferably the heat-frangible covering is made from a non-flexible material.

Preferably the heat-frangible covering is not air or moisture sensitive. Preferably the heat-frangible covering is not light sensitive. Preferably the heat-frangible covering is chemically resistant.

Preferably the heat-frangible covering is made from a polymeric material. Preferred polymeric materials include polyethylene (including high density polyethylene and low density polyethylene), polypropylene, polyvinyl chloride, vinyl polymers, polyethylene terephthalate (PET, PETE) and polystyrene.

One especially preferred heat-frangible covering material is low density polyethylene.

Preferably the heat-frangible covering melts on application of heat. Suitably the heat-frangible covering is in the form of a film and melting following application of heat causes the film to break apart.

Preferably the heat-frangible covering is made from a material having a melting point of less than 300° C., preferably less than 250° C., more preferably less than 200° C., for example less than 180° C., less than 160° C. or less than 140° C.

Suitably the heat-frangible covering is made from a material having a melting point of 70° C. to 150° C., preferably 80° C. to 130° C., for example 90° C. to 120° C.

The heat frangible covering is preferably arranged such that upon breaking the expandable covering can completely expand. Suitably the heat frangible covering is arranged such that upon breaking the compressed expandable non-combustible material can expand evenly across the cavity.

The fire barrier product of the present invention may further comprise a non-combustible adhesive material. The non-combustible adhesive material may be selected from any suitable material that is able to cause adhesion between two other materials and which does not burn.

In some embodiments the non-combustible adhesive material may be arranged between the compressed expandable non-combustible material and the intumescent composition. The non-combustible adhesive material is suitably able to adhere to both the compressed expandable non-combustible material and the intumescent composition.

In some embodiments a fire barrier product of the present invention further comprises a support. Suitably the support is arranged to hold the compressed expandable non-combustible material, the intumescent composition, the expandable covering and the heat frangible covering in position.

The arrangement of these components within or on the support may depend on the type of cavity in which the fire barrier product is intended to be used. The support may comprise multiple parts. The other components of the fire barrier product may be carried by the same or different portions of the support.

The support suitably is a non-combustible support. It may be prepared from any suitable material. In some embodiments the support may comprise a non-combustible coating.

Suitably the support is formed from a material selected from high density mineral wool, glass wool, calcium silicate, magnesium oxide board, ceramic board, brick work, block work, cement, concrete, wood or bakelite.

Suitably the intumescent composition is arranged within the fire barrier product such that in a fire intumescence further closes the cavity. Suitably the intumescent material is arranged such that on expansion it applies a compressive force to the expanded expandable non combustible material to close the cavity.

The intumescent composition may be arranged between the support and the compressed expandable non-combustible material such that when expanded it pushes the expanded expandable non-combustible material further into the cavity.

Alternatively the intumescent composition may be arranged on a different portion of the support on the opposite side of the cavity to the compressed expandable non-combustible material such that when expanded the intumescent composition pushes against the expanded expandable non-combustible material.

The intumescent composition may be applied to at least a portion of a surface of the compressed expandable non-combustible material. Strips of intumescent material may be arranged as a layer on at least a portion of a surface of the compressed expandable non-combustible material.

Suitably the layer of intumescent composition is arranged on of a surface of the compressed expandable non-combustible material such that in use the intumescence further closes the cavity.

In some embodiments the intumescent composition may be applied on a different portion of the support. In such embodiments the intumescent composition is not surrounded by the expandable covering.

Suitably the fire barrier product of the first aspect is adapted to be fixed to a structure. Such a structure may be a wall, a floor, a roof cantilever or a gable vent.

The structure may include a cavity for the purpose of ventilation, drainage or access.

The structure to which the fire barrier product fixed may be made from stone, concrete, brick, metal, wood, ceramic, glass, plastic, gypsum, plaster, mineral fibres, mineral boards or any combination thereof.

The cavity may be present internally or externally to a building.

In some embodiments the compressed expandable non-combustible material may be shaped to facilitate fixing to a wall.

In some embodiments the fire barrier product of the first aspect may comprise fixing means. The fixing means may be attached to the compressed expandable non-combustible material to facilitate fixing the fire barrier to a wall or other structure.

In some embodiments separate fixing means may be used.

Suitably the fire barrier product is configured such that when fixed to a wall or other structure a layer of intumescent composition is provided between the wall and the compressed expandable non-combustible material.

According to a second aspect of the present invention there is provided a kit comprising a fire barrier product of the first aspect and fixing means.

Preferred features of the second aspect are as defined in relation to the first aspect.

Fixing means may be provided within the fire barrier product of the first aspect or separately as part of the kit of the second aspect.

Any suitable means by which the fire barrier product can be attached to a wall or other structure can be used as a fixing means.

Such means include adhesives, cup head pins, spikes, angles, shelves, brackets, channels, adhesives, screws, bolts or other fixings.

The fire barrier product of the present invention offers a number of advantages over products of the prior art. It is made of cheap, readily available materials.

A variety of conventional fixing means can be used to secure the fire barrier product of the first aspect in position.

A fire barrier product of the invention can be made in any size or shape and thus can be used in a wide variety of settings.

Depending on the covering used, the barrier can be activated at much lower temperatures than prior art systems which rely solely on intumescent materials. This means that a barrier across a cavity is formed much sooner when a fire starts. For example low density polyethylene suitable for use as a covering material has a melting point of 105° C. whereas graphite based intumescent materials do not expand until temperatures of at least 150° C. are reached.

When the intumescent composition expands to form a char on exposure to fire the char applies pressure to the expandable non-combustible material. This advantageously provides a tight seal by partially recompressing the expanded non-combustible material.

The expandable covering advantageously remains intact during expansion of the compressed expandable non-combustible material and the intumescent composition, even on breaking of the heat-frangible covering so as to prevent the compressed expandable non-combustible material and the intumescent composition from falling away from the fire barrier product. The expandable covering may also advantageously direct the expansion of the intumescent char into the expanded non-combustible material, so as to provide a more effective recompression.

Because the fire barrier product is made from mainly non-combustible materials there is no increase in energy release due to the fire.

The materials used to made the fire barrier product of the present invention are suitably very durable and have a long service life. No maintenance is required after installation.

The fire barrier product of the invention can be used within cavities of external walls, including those exposed to the elements. It can also be built into a frame, to be used as an air ventilation device.

In some embodiments a plurality of fire barrier products of the invention can be used in series, for example across a large cavity.

The fire barrier product of the invention can be used in a vertical cavity or a horizontal cavity.

According to a third aspect of the present invention there is provided a method of forming a closure across a cavity, the method comprising fixing a fire barrier product of the first aspect within the cavity and heating the fire barrier product.

The invention will now be further described with reference to the accompanying drawings in which:

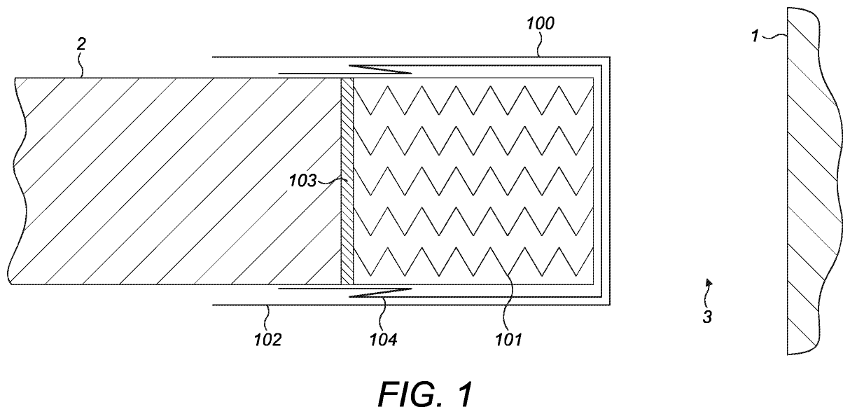

FIG. 1 shows one example of how the fire barrier product may be fitted within an open cavity.

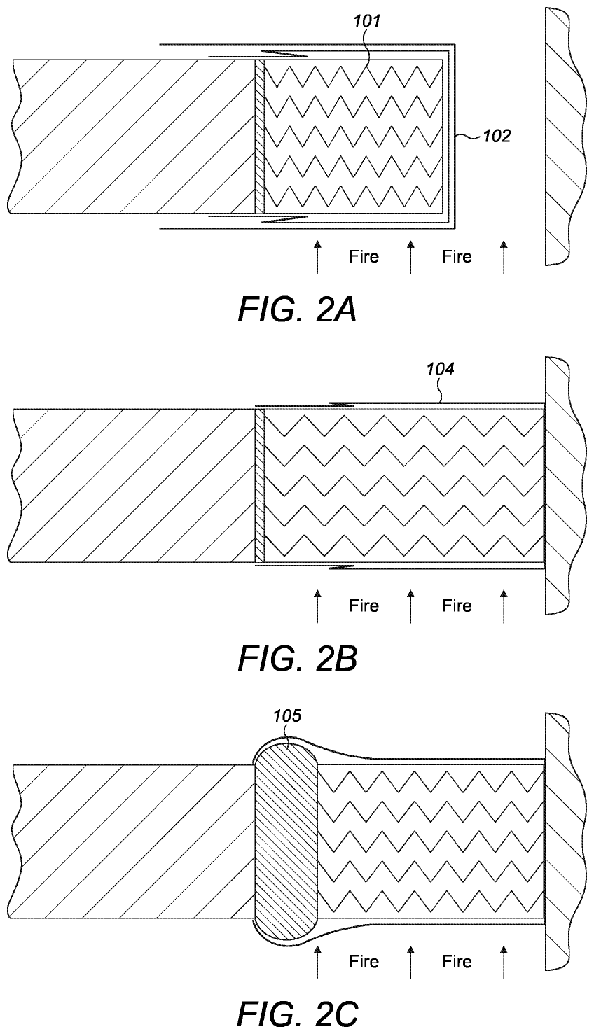

FIG. 2 shows the mode of action of the product on exposure to fire.

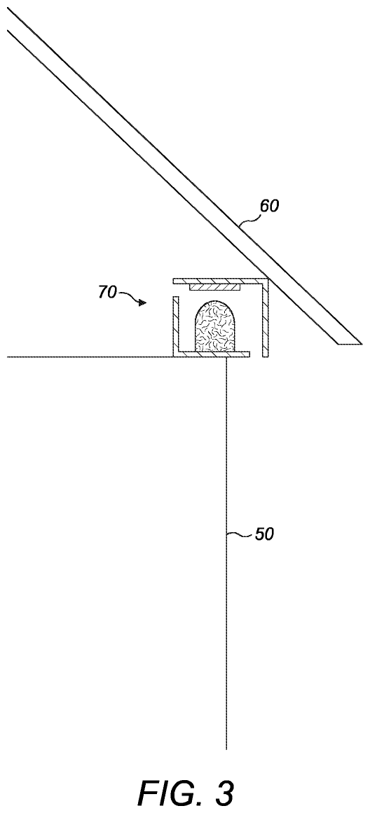

FIG. 3 shows a cross sectional view through a further fire barrier product of the invention within the eaves ventilation of a roof;

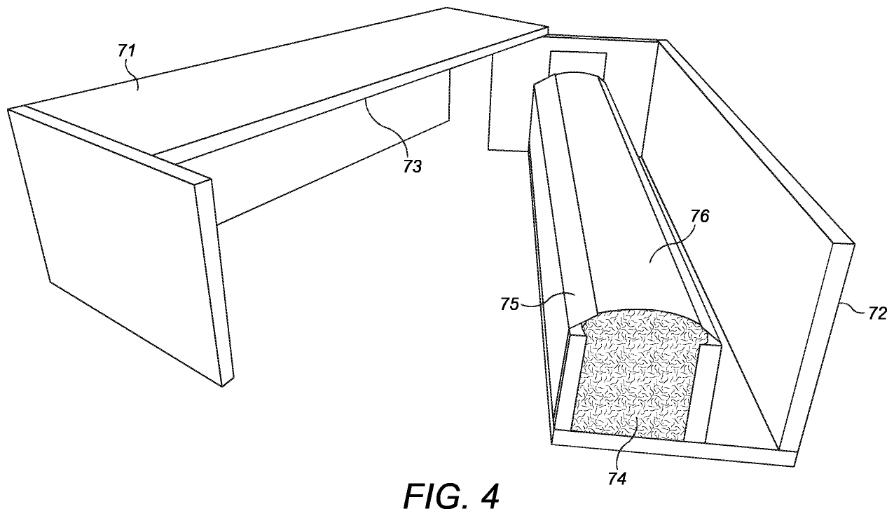

FIG. 4 is an expanded view of the product of FIG. 3;

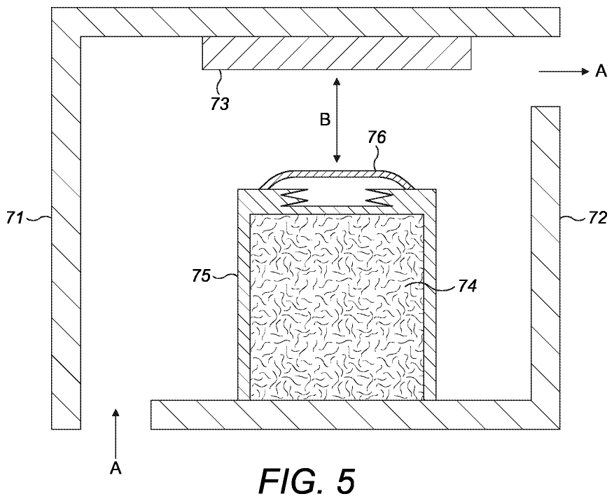

FIG. 5 is a larger cross-sectional view a product of FIG. 3;

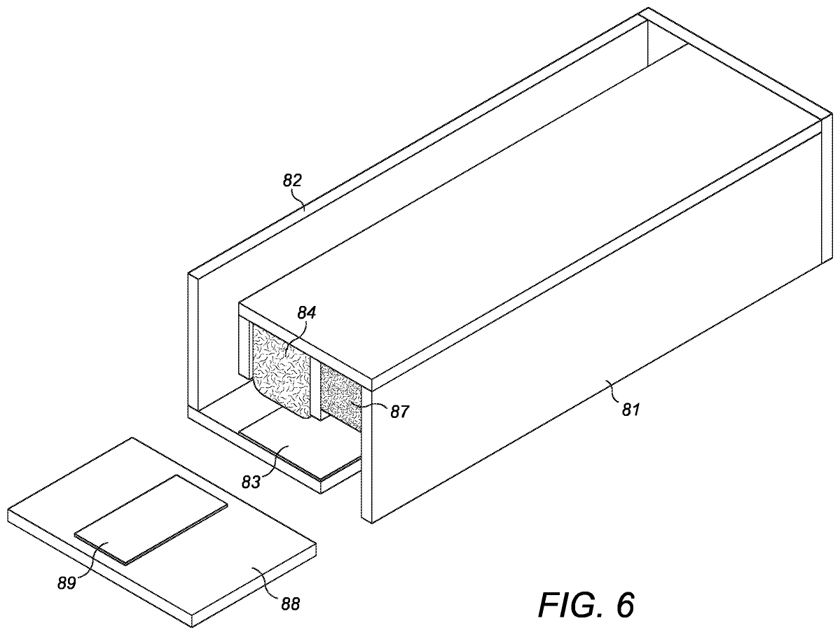

FIG. 6 is an expanded view of a further product suitable for use in the eaves ventilation of a roof; and

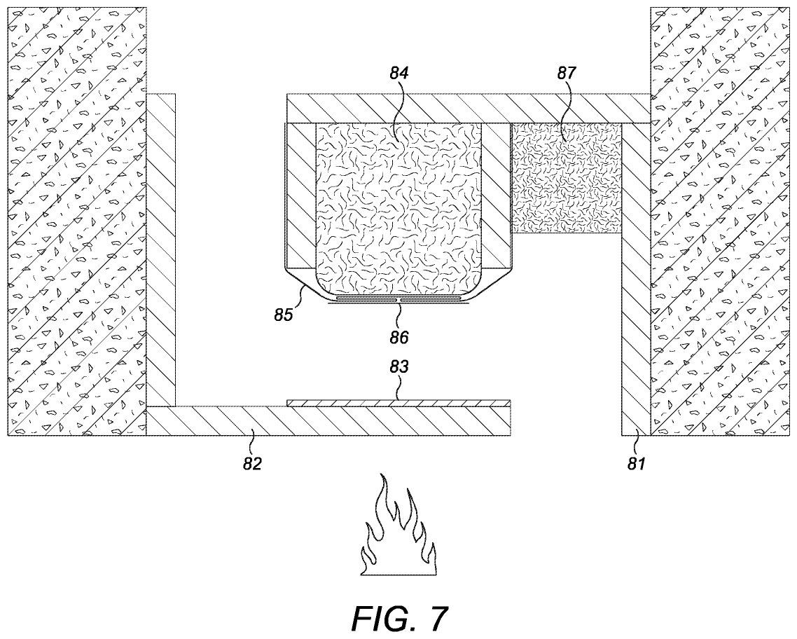

FIG. 7 is a cross-sectional view a product of FIG. 6.

FIG. 1 shows a substrate 2 fitted within cladding 1, with a cavity 3 (air gap) therebetween. A fire barrier product 100 is fitted to the substrate 2 with a suitable fixing. The fire barrier product 100 comprises a compressed expandable non-combustible material in the form of mineral wool 101 in a compressed form held in place by a heat-frangible polyethylene covering 102. An intumescent composition 103 is disposed between the substrate 2 and the mineral wool 101 and attached to the mineral wool 101 by a non-combustible adhesive. The heat-frangible polyethylene covering 102 is attached to the substrate 2 by a suitable adhesive to bias the mineral wool 101 in the compressed form. An expandable aluminium foil covering 104 is disposed between the heat-frangible polyethylene covering 102 and the mineral wool 101 and intumescent composition 103. The expandable aluminium foil covering 104 is attached to the substrate 2 using an adhesive or tape and comprises folds. Air can flow through the cavity 3.

FIG. 2 shows the mode of action of the fire barrier product 100 of FIG. 1 in three stages (A, B, C).

FIG. 2A shows the fire barrier product 100 on initial exposure to fire. The fire causes the polyethylene covering 102 to break, releasing the compressive force on the mineral wool 101.

FIG. 2B shows the fire barrier product 100 after the mineral wool 101 has expanded outwards from the substrate 2 to block the entire cavity 3 and form a barrier meaning that heat and fire are unable to pass the barrier. The aluminium foil covering 104 has partially expanded (unfolded) so as to accommodate the expanded mineral wool 101.

FIG. 2C shows the fire barrier product after a high enough temperature is reached that the intumescent composition 103 has formed an expanded intumescent char 105. The aluminium foil covering 104 has now fully expanded (unfolded) to accommodate the intumescent char 105 and to direct pressure caused by the expansion of the intumescent char 105 into the mineral wool 101. The pressure applied to the mineral wool 101 maintains the barrier across the cavity 3. The aluminium foil covering 104 prevents the intumescent char 105 and the mineral wool 101 from falling out of the barrier and also prevents smoke from penetrating the barrier.

FIG. 3 shows a building including a wall 50 and a roof 60. Fitted in the venting cavity therebetween is a firestop product of the invention 70.

The firestop product comprises two portions 71 and 72 including calcium silicate support structures which fit together to retain a cavity through which air can flow normally (arrows A in FIG. 5) but which can be closed (across section B in FIG. 5).

On one portion of the support is a strip of intumescent composition 73. The other portion of the support carries a compressed expandable non-combustible material 74 (mineral wool) surrounded by an expandable foil covering 75 sealed in a compressed position by heat frangible polyethylene seal 76.

On exposure to fire a seal is formed across B closing the cavity.

The firestop product of FIG. 6 comprises two portions 81 and 82 including calcium silicate support structures which fit together to retain a cavity through which air can flow normally.

On one portion of the support is a strip of intumescent composition 83. The other portion of the support carries a compressed expandable non-combustible material 84 (mineral wool) surrounded by an expandable foil covering 85 sealed in a compressed position by heat frangible polyethylene seal 86.

An additional portion of mineral 87 provides support and ensures the required spacing for the unit.

The product is fitted with an end panel 88 which carries further strip of intumescent material 89.

1. A fire barrier product for a cavity comprising a compressed expandable non-combustible material, an intumescent composition, an expandable covering and a heat-frangible covering.

2. A fire barrier product according to claim 1 wherein the compressed expandable non-combustible material is selected from man made mineral fibres (MMMFs) and man made vitreous fibres (MMVFs).

3. A fire barrier product according to claim 1 wherein the compressed expandable non-combustible material is selected from one or more of mineral wool, mineral fibres, mineral cotton, vitreous fibres, stone wool, slag wool, glass wool, ceramic fibre, ceramic wool and other man made fibres.

4. A fire barrier product according to claim 1 wherein the intumescent composition is coated on at least a portion of a surface of the compressed expandable non-combustible material.

5. A fire barrier product according to claim 1 wherein intumescent composition comprises an intumescent material comprising phosphorus, sulfur, a halogen, a melamine compound, boron, a polyol or a mixture thereof.

6. A fire barrier product according to claim 1 further comprising a non-combustible adhesive material.

7. A fire barrier product according claim 6 wherein the non-combustible adhesive material is arranged between the compressed expandable non-combustible material and the intumescent composition.

8. A fire barrier product according to claim 1 wherein the expandable covering is arranged between the compressed expandable non-combustible material and the heat-frangible covering.

9. A fire barrier product according to claim 1 wherein the expandable covering is provided in the form of a film.

10. A fire barrier product according to claim 1 wherein the expandable covering comprises a metal.

11. A fire barrier product according to claim 1 wherein the heat-frangible covering is provided in the form of a film.

12. A fire barrier product according to claim 1 wherein the heat-frangible covering comprises a polymeric material.

13. A fire barrier product according to claim 1 wherein the heat-frangible covering is made from a material having a melting point of 70° C. to 150° C.

14. A fire barrier product according to claim 1 which further comprises a support.

15. A fire barrier product according to claim 14 wherein the intumescent composition is arranged on a different portion of the support on the opposite side of the cavity to the compressed expandable non-combustible material.

16. A fire barrier product according to claim 1 which further comprises fixing means.

17. A kit comprising a fire barrier product as claimed in claim 1 and fixing means.

18. A fire barrier product according to claim 16 wherein the fixing means is selected from spikes, angles, shelves, brackets, channels, adhesives, screws, bolts or other fixings.

19. A method of forming a closure across a cavity, the method comprising fixing a fire barrier product according to claim 1 within the cavity and heating the fire barrier product.
